(19) United States
(12) Patent Application Publication
(10) Pub. No.: US 2014/0363283 A1
(43) Pub. Date: Dec. 11, 2014

(54) SHROUD ARRANGEMENT FOR A FLUID FLOW MACHINE

(71) Applicant: Rolls-Royce Deutschland Ltd & Co KG, Blankenfelde-Mahlow (DE)

(72) Inventor: Volker GUEMMER, Mahlow (DE)

(73) Assignee: Rolls-Royce Deutschland Ltd & Co KG, Blankenfelde-Mahlow (DE)

(21) Appl. No.: 14/295,499

(22) Filed: Jun. 4, 2014

(30) Foreign Application Priority Data
Jun. 5, 2013 (DE) 10 2013 210 427.8

(51) Int. Cl. F01D 11/00; F01D 5/30; F01D 9/02

(52) U.S. Cl. CPC F01D 11/005; F01D 9/02; F01D 5/30; F05D 2240/11
USPC 415/208.1; 416/193 A

(57) ABSTRACT

A shroud arrangement for a fluid-flow machine includes a blade root connected to at least one blade/vane end of a row of rotor blades or stator vanes, or is connected to at least one such blade/vane end. A shroud is connected to the blade root on the side of the blade root facing away from the blades/vanes. The blade root on the side facing away from the blades/vanes has two blade root fingers extending substantially in the radial direction and axially spaced from one another, the blade root fingers forming between them a recess being continuous in the circumferential direction. An element or area of the shroud for fastening to the blade root is arranged in the recess. The shroud has two webs extending into the recess and enclosed by the blade root fingers, with the two webs forming substantially a V-shaped arrangement.

### CROSS-REFERENCE TO RELATED APPLICATION

This application claims priority to German Patent Application No. 10 2013 210 427.8 filed on Jun. 5, 2013, the entirety of which is incorporated by reference herein.

### BACKGROUND

This invention relates to a shroud arrangement for a fluid-flow machine.

The aerodynamic loadability and the efficiency of fluid-flow machines, in particular of fluid-flow machines such as blowers, compressors, pumps and fans, is limited, among others, by the leakage flows on the boundaries of the main flow path. One source of the losses occurring in fluid-flow machines is the leakage flow around the blade shrouds. These losses frequently occur on the inner end of stator vanes or on the outer end of rotor blades.

A leakage flow of this kind is usually minimized by sealing fins which are arranged within a cavity, in which the shroud is embedded. An arrangement of this kind is known for example from DE 10 2010 055 435 A1 and US 2003/0170115 A1. In small fluid-flow machines in particular, structural implementation of a shroud arrangement in an axially narrow space is however difficult.

A shroud arrangement is known from US 2007/0065286 A1 where a recess is formed on the blade root, in which are arranged two webs with projections of a shroud facing away from one another.

### SUMMARY

An object underlying the present invention is to provide a shroud arrangement for a row of a rotor blades or stator vanes of a fluid-flow machine that can be implemented also in an axially narrow space.

According to An embodiment of the invention assumes a shroud arrangement for a fluid-flow machine provided with at least one blade root and one shroud. The blade root is designed to be connected to at least one blade/vane end of a row of rotor blades or stator vanes of a fluid-flow machine, or is connected to at least one such blade/vane end. The shroud is connected to the blade root on that side of the blade root facing away from the blades. In accordance with the invention, it is provided that the blade root has on that side facing away from the blades (i.e. on the side facing away from the main flow path of the fluid-flow machine) two blade root fingers extending substantially in the radial direction and axially spaced from one another. The blade root fingers form between them a continuous recess in the circumferential direction. Here, at least one element or at least one area of the shroud is arranged in the recess for fastening the shroud to the blade root. This involves in accordance with the invention two webs extending into the recess and enclosed by the blade root fingers, with the two webs forming substantially a V-shaped arrangement. The two webs correspond here to mating contact faces of the blade root fingers and are held positively inside the recess. The two webs are spaced in the axial direction.

The solution in accordance with the invention is thus based on the idea of providing, in a blade root between two axially spaced blade root fingers, a recess used for receiving and fastening a shroud. The shroud arrangement according to the present invention can also be provided in an axially narrow space by selecting a small axial spacing of the blade root fingers. This does not restrict the possibilities for fastening of a shroud, since the at least one element or the at least one area of the shroud incorporated into the recess defined between the blade root fingers can also be designed correspondingly small in its axial extent.

The solution in accordance with the invention has the advantage that an elasticity is achieved by the two webs and their V-shaped arrangement that permits compensation of production tolerances, such that the shroud is arranged without any clearance in the recess of the blade root.

In an embodiment of the invention, it is provided that the recess formed by the blade root fingers has a concave shape. For example, the recess is designed dovetail-shaped in at least in one part-area, widening in the direction of the blades/vanes. The two webs are arranged positively inside the recess, where in each case a web is in contact with a corresponding contact face of a blade root finger. In particular, the webs arranged in a V-shape each extend parallel to an inner contact face of one of the blade root fingers.

According to a further embodiment of the invention, each blade root finger forms at least one inner contact face which is at least partially facing the inner contact face of the respective other blade root finger. It can be provided here that at least one of the inner contact faces is arranged obliquely to the radial direction and to the axial direction while facing the blades. The oblique inner contact faces lead to the recess formed by the blade root fingers widening at least in some sections in the radial direction towards the blades in respect of its axial extent, allowing an element or area of the shroud to be securely held in the recess. It can further be provided that at least one of the two inner contact faces is designed flat over one area.

According to a further embodiment of the invention, at least one of the blade root fingers has locking means for engagement with an element or area of the shroud. Engagement of this type secures the connection between blade root and shroud.

It can furthermore be provided that the shroud ring is interrupted several times in the area of the webs on the circumference, so that the webs are to an increasing degree designed elastic. For example, the number of interruptions of the two webs on the circumference matches the number of blades/vanes or forms a multiple thereof. Said webs can also have in the contact area with the blade root a locking lug for a positive engaging connection to the blade root fingers in the area of the recess.

The shroud arrangement in accordance with the invention is preferably provided to interact, in the case of its connection to a rotor blade row, with sealing fins extending from a casing radially adjoining it on the outside, and in the case of its connection to a stator vane row, with sealing fins of a radially inward hub or rotor drum.

In a further exemplary embodiment of the invention, the shroud has a shroud ring arranged in the recess of the blade root and extending along at least part of the circumference of the blade row. The shroud ring thus extends for example along the entire circumference of the blade row or along part of the circumference of the blade row.

According to a design variant, an abradable coating is arranged on the shroud ring on that side of the shroud ring facing away from the blade root. This coating is usually made of a softer material than the shroud ring and is intended for sealing fins of an adjoining casing or an adjoining hub to rub into it in order to minimize an existing leakage flow. Alternatively, it can be provided that the function of the shroud ring and the function of the abradable coating are assured by one component, i.e. shroud ring and abradable coating are implemented in one component.

Usually it is provided that in the fluid-flow machine in which the shroud arrangement in accordance with the invention is used, that side of the blade root facing the rotor blades or stator vanes forms the boundary of the main flow path, while that side of the blade root facing away from the blades is arranged in a cavity of the adjoining flow-limiting structure (casing or hub/rotor drum). Generally speaking however, embodiments differing from this are also possible.

In an embodiment of the invention, at least one of the blade root fingers has at its end a radial contact face facing away from the blades. The shroud or, where used, an anti-wear sleeve is also in contact with said contact face. In particular, it can be provided that the shroud is in contact in at least one of its axially front and rear boundary areas with a radial contact face of a blade root finger.

In a further embodiment of the invention, the recess between the blade root fingers has a symmetrical shape. In this case, the blade root fingers too are arranged symmetrically on the blade root.

It is possible with the shroud arrangement in accordance with the invention to insert at least one anti-wear sleeve, which is arranged between adjoining faces of the blade root and of the shroud ring. An anti-wear sleeve of this type reduces the risk of wear on the blade root and shroud at their adjoining faces and hence the risk of loosening the connection between blade root and shroud. It can however also be alternatively provided that no anti-wear sleeve is inserted, so that the shroud ring is in direct contact with the blade root at its radial and/or inner contact faces.

A further embodiment of the invention provides that the shroud ring is, in its section facing the blades, enclosed by the blade root fingers and has a cross-sectional shape similar to the recess in the blade root.

The cross-section of the shroud ring can have in an embodiment of the invention a continuous recess in the circumferential direction. It can be provided that a recess of this type in the shroud ring is inserted from the side facing the main flow path or from the side facing away from the main flow path. The recess can define structures of the shroud which are arranged inside the recess of the blade root.

An embodiment of the invention provides that the two webs arranged in a V-shape are connected to one another at their ends projecting into the recess of the blade root by a base facing the blade root, with a material-free interior remaining between the webs and the base. Overall, the result of this is an arrangement triangular in section. It can be provided here that the arrangement of the two webs and the base in the sectional view is designed approximately corresponding to the Greek letter Omega (Ω). By providing a material-free interior, an elasticity of the overall arrangement is assured, despite the connection of the two webs by a base, which permits the compensation of any production tolerances present or any clearance caused by them.

According to a design variant of the invention, the shroud or the shroud ring forms in the direction of the blades/vanes in the cross-section of the meridional plane a triangular projection arranged in the recess. Two legs of the triangular projection formed by the two webs arranged in a V-shape are here in contact with corresponding inner oblique contact faces of the blade root fingers. It can be provided here that the triangular projection has at least approximately the shape of the Greek letter Omega (Ω) and accordingly the two legs of the triangular projection do not touch one another on the side facing away from the main flow path, and instead the triangular projection has a recess on the side facing away from the main flow path.

The present invention generally relates to blade rows for fluid-flow machines, such as turbines, and in particular to fluid-flow machines such as blowers, compressors, pumps and fans of the axial or semi-axial type. The working medium may be gaseous or liquid. The fluid-flow machine may include one or several stages, each having a rotor and a stator. In individual cases, the stage is formed only by a rotor.

The rotor of a fluid-flow machine, in which a shroud arrangement in accordance with the present invention is used, includes a number of blades, which are connected to the rotating shaft of the fluid-flow machine. The stator of a fluid-flow machine, in which a shroud arrangement in accordance with the present invention is used, includes a number of stationary vanes. The rotor drum and the blading are usually enclosed by a casing.

A fluid-flow machine, in which a shroud arrangement in accordance with the present invention is used, may also feature a stator, a so-called inlet guide vane assembly, upstream of the first rotor. Departing from a stationary fixation, at least one stator or inlet guide vane assembly may be rotatably borne, to change the angle of attack. Variation is accomplished for example via a spindle accessible from the outside of the annular duct.

In an embodiment, a fluid-flow machine, in which a shroud arrangement in accordance with the present invention is used, may include at least one row of variable rotors.

In an embodiment, a fluid-flow machine, in which a shroud arrangement in accordance with the present invention is used, may have two counter-rotating shafts, in the event of a multi-stage design, with the direction of rotation of the rotor blade rows alternating between stages. Here, no stators exist between subsequent rotors.

In an embodiment, a fluid-flow machine, in which a shroud arrangement in accordance with the present invention is used, may feature a bypass configuration such that a single-flow annular duct divides into two concentric annular ducts behind a certain blade row, with each of these annular ducts containing at least one further blade row.

The present invention furthermore relates to a blade row of a fluid-flow machine having a shroud arrangement in accordance with the present invention.

### BRIEF DESCRIPTION OF THE DRAWINGS

The present invention is described in the following with reference to the figures of the accompanying drawing, showing several exemplary embodiments.

FIG. 1A schematically shows a rotor provided with a shroud.

FIG. 1B schematically shows a stator provided with a shroud.

FIG. 2A shows an exemplary embodiment of a shroud arrangement in accordance with the state of the art.

FIG. 2B shows an enlarged representation of the area X of the exemplary embodiment of FIG. 2A.

FIG. 3 shows a first exemplary embodiment of a blade root of a shroud arrangement.

FIG. 4 shows a first exemplary embodiment of a shroud arrangement using the blade root of FIG. 3 and a first exemplary embodiment of a shroud.

FIG. 5 shows a second exemplary embodiment of a shroud arrangement using the blade root of FIG. 3 and a second exemplary embodiment of a shroud.

FIG. 6 shows a third exemplary embodiment of a shroud arrangement using the blade root of FIG. 3 and a third exemplary embodiment of a shroud.

FIGS. 7a-c show shroud arrangements according to FIGS. 4 to 6, each of them however being designed without anti-wear sleeve.

FIG. 8 shows a further exemplary embodiment of a shroud arrangement.

FIG. 9 shows an exemplary embodiment of a shroud arrangement, where a shroud ring and an abradable coating of the shroud are designed in one piece.

### DETAILED DESCRIPTION

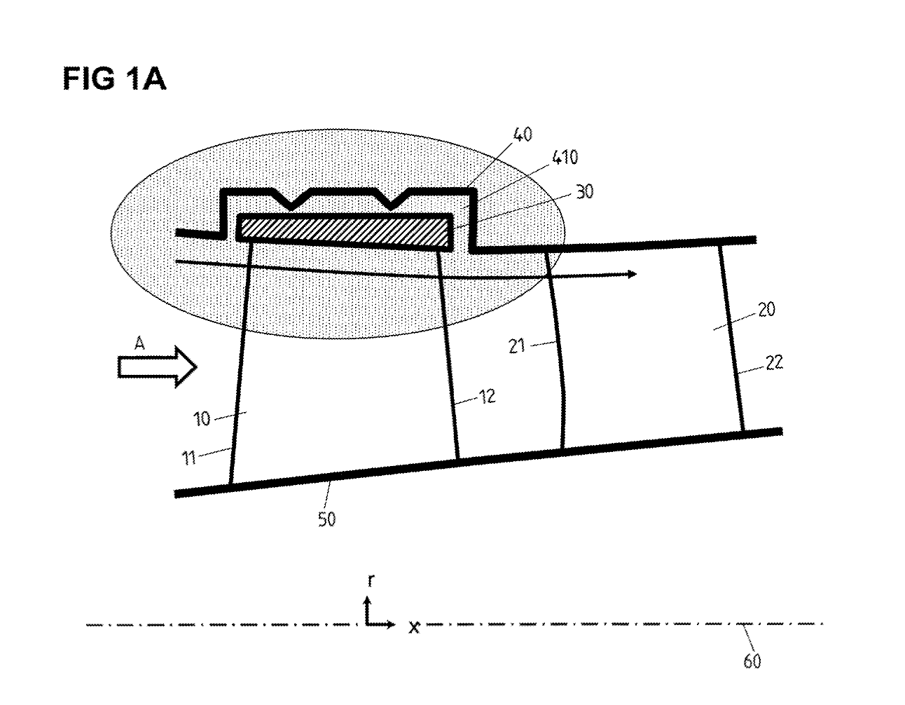

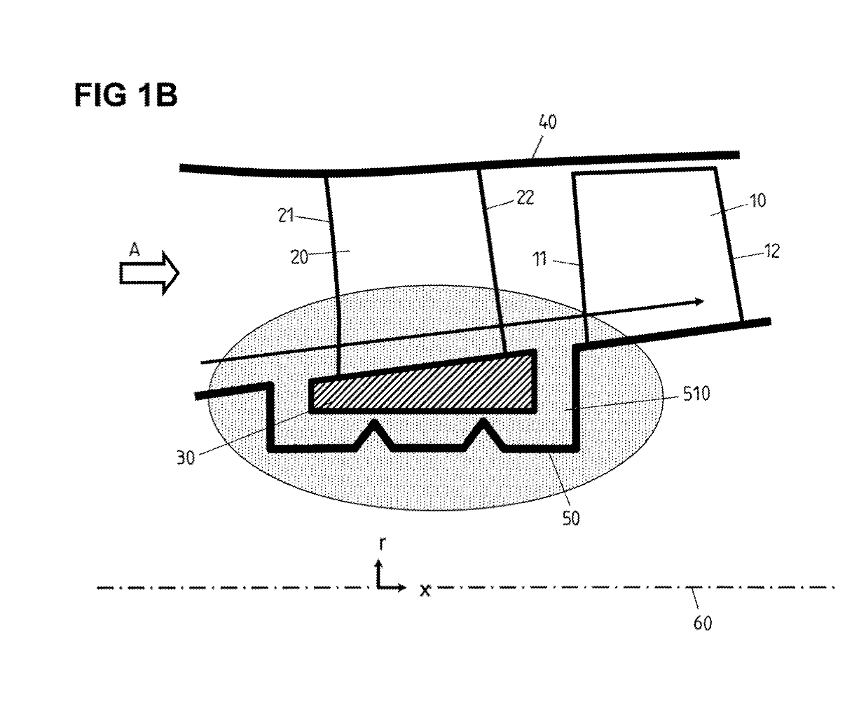

FIG. 1A schematically shows in the meridional view—x indicating the axial direction and r indicating the radial direction—a section of a fluid-flow machine that includes a rotor blade row with a plurality of rotor blades 10 and a stator vane row with a plurality of stator vanes 20. Each rotor blade 10 has a leading edge 11 and a trailing edge 12 and each stator vane 20 has a leading edge 21 and a trailing edge 22. The fluid-flow machine can be an energy-receiving or an energy-supplying fluid-flow machine. For example, the rotor blade row and the stator vane row are arranged in a compressor or in a turbine of a jet engine.

The fluid-flow machine forms a main flow path in which a fluid flows in the flow direction A. The main flow path is limited radially on the inside by a hub or rotor drum 50 and radially on the outside by a casing 40. The hub/rotor drum 50 is designed rotating here, while the casing 40 is designed stationary, i.e. non-rotating.

A shroud arrangement 30 shown schematically is provided on the outer blade end of the rotor blades 10. It is received in a cavity 410 provided in the casing 40 for creating an outer main flow path boundary which is as smooth as possible.

Also shown in FIG. 1A is the machine axis 60.

FIG. 1B schematically shows a section of a fluid-flow machine designed according to the fluid-flow machine of FIG. 1A, where in FIG. 1B a shroud arrangement 30 is provided, however not on the rotor but on the stator. Accordingly, the shroud arrangement 30 is provided on the radially inner vane end of the stator vanes 20. The shroud arrangement 30 is here provided in a cavity 510 formed by the rotating hub/rotor drum 50.

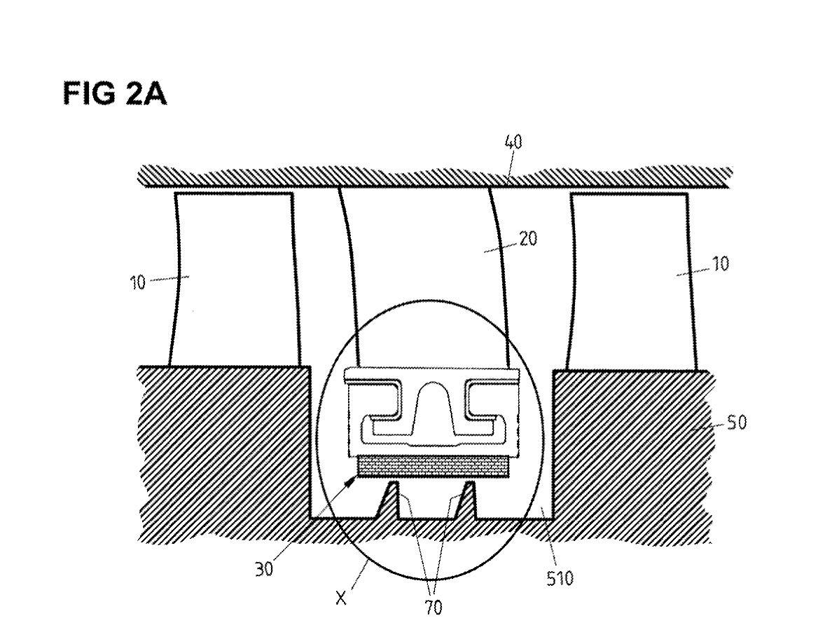

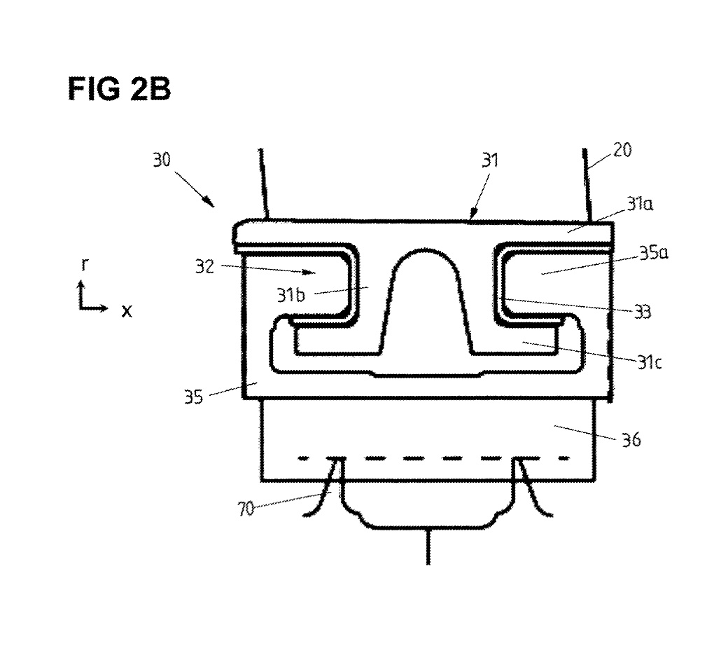

For a better understanding of the present invention, the following initially describes on the basis of FIGS. 2A and 2B a shroud arrangement according to the state of the art, as is used for example in the TRENT 1000 engine of the company Rolls-Royce. FIG. 2A shows a corresponding section of a fluid-flow machine, where a stator vane row with stator vanes 20 is arranged between two rotor blade rows with rotor blades 10. Furthermore, a stationary casing 40 and a rotating hub 50 are provided, as explained with reference to FIG. 1A. A shroud arrangement 30 is provided at the stator vane row radially on the inside within a cavity 510 in the hub 50, with sealing fins 70 of the hub 50 projecting up to said shroud arrangement. The area X of FIG. 2A is shown enlarged in FIG. 2B.

FIG. 2B shows the shroud arrangement 30 in the meridional plane of the fluid-flow machine established by the axial direction x and the radial direction r. This representation is generalized to the extent that the arrangement shown is valid both for a rotor blade with radially outward shroud arrangement and sealing fins extending from the casing, and for a stator vane with radially inward shroud arrangement and sealing fins extending from the hub or rotor drum.

The shroud arrangement has as main components a blade root 31 and a shroud ring 35, with the shroud ring 35 being positively fastened to the blade root 31. The blade root 31 includes a blade root platform 31a, two blade root webs 31b protruding substantially perpendicularly and blade root fingers 31c protruding forwards or rearwards from the latter in the axial direction. Two outer circumferential grooves 32 are formed here between the blade root fingers 31c and the blade root platform 31a, said grooves being engaged by two fingers 35a of the shroud ring 35 facing one another in the axial direction. It can further be provided that an anti-wear sleeve 33 is provided as shown between the surfaces of the blade root 31 and the shroud ring 35 facing one another.

The blade root 31 and the stator vane 20 can be designed in one piece.

The shroud ring 35 has on its side facing away from the main flow path an abradable coating 36 facing the sealing fins 70. The sealing fins 70 form here part of the hub or rotor drum and rotate accordingly relative to the static shroud arrangement 30. The sealing fins 70 here rub into the abradable coating 36 in order to minimize leakage between hub and stator vanes. If the shroud arrangement is provided on the blades of a rotor, the shroud arrangement rotates relative to a non-rotating casing with non-rotating sealing fins.

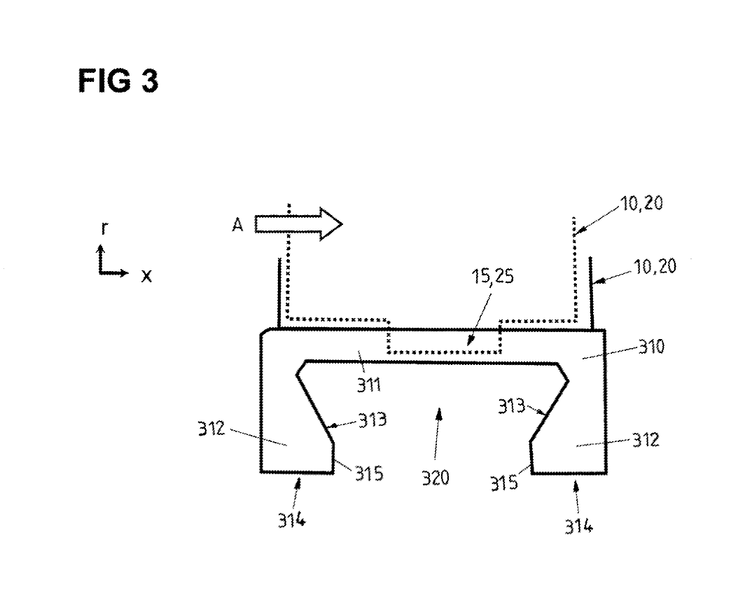

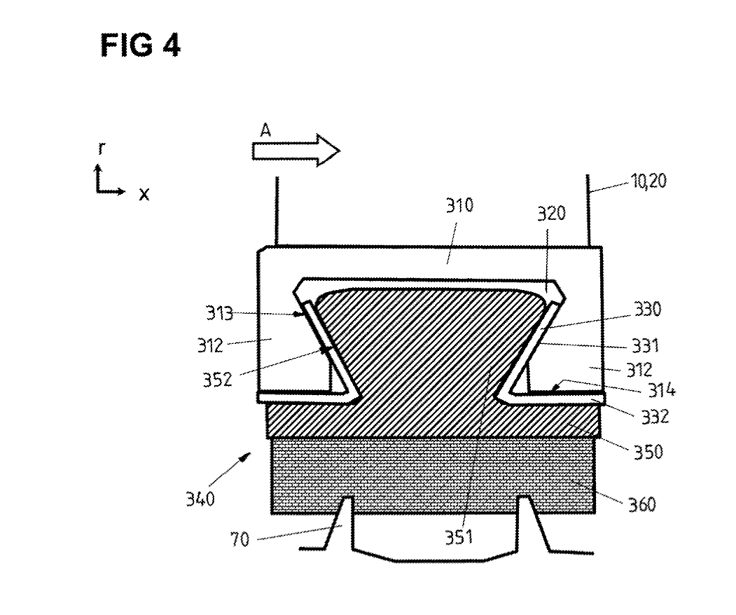

FIG. 3 shows an exemplary embodiment of a shroud arrangement in accordance with the invention, where in FIG. 3 only the blade root of the shroud arrangement is shown, and not yet the shroud. The connection of the blade root described in FIG. 3 to various shrouds is illustrated in FIGS. 4 to 6.

Arrow A indicates the direction of flow in the main flow path. As explained with reference to FIGS. 1A, 1B, a rotor blade row or a stator vane row with rotor blades 10 or stator vanes 20 is located in the main flow path, among others, with a shroud arrangement being arranged on the inside or outside at its ends. FIG. 3 indicates schematically the profile of such a rotor blade 10 or stator vane 20. It merges at the inner end (in the case of the stator) or at the outer end (in the case of the rotor) into a blade root 310, which there forms the boundary of the main flow path A with the side facing the blade profile.

Two design variants are indicated here in FIG. 3. The continuous line indicates a design variant in which the blade/vane profile 10, 20 is firmly connected to a blade root 310. The dotted line indicates a design variant in which the blade/vane profile 10, 20 is rotatably mounted in the blade root 310. The rotatable mounting is achieved using a plate 15, 25 provided on the blades/vanes 10, 20. The rotor blades 10 or stator vanes 20 can therefore be arranged rotatable or non-rotatable.

The blade root 310 includes a blade root platform 311 connected to the end of the blade/vane 10, 20 and extending at least over part of the circumference of the blade row. At the axially forward and at the axially rearward end of the blade root platform 311, the blade root 310 forms two blade root fingers 312 pointing away from the main flow path or the blades/vanes 10, 20 (an axially forward and an axially rearward blade root finger). These form faces 313, 315 facing one another on the inside, where the blade root 310 has a recess 320 between the two blade root fingers 312.

The blade root fingers 312 furthermore form on their front face facing away from the main flow path a radial contact face 314.

The inner contact faces 313, 315 each include an oblique inner contact face 313, arranged obliquely relative to the axial direction and the radial direction and facing the blades/vanes 10, 20. The contact faces 315 extend in the radial direction and protrude perpendicularly from the front radial contact face 314. Accordingly, the recess 320 in the exemplary embodiment shown is designed dovetail-like, with the recess 320 formed by the blade root fingers 312 widening in the radial direction towards the blades/vanes 10, 20 or to the main flow path in respect of its axial extent.

The two blade root fingers 312 are suitable for enclosing an element of a shroud or an area of a shroud inserted into the recess 320 of the blade root 310 and for holding it on the blade root 310.

The recess 320 between the blade root fingers 312 has a symmetrical shape, in the same way as the blade root 310 itself has a symmetrical shape. The contact faces 313, 315 can each be designed flat, but alternatively also have a structured surface, for example for providing locking elements.

FIG. 4 shows an exemplary embodiment of a shroud arrangement in which a shroud 340 is inserted into the blade root 310 of FIG. 3. The shroud 340 includes a shroud ring 350 and an abradable coating 360 arranged on that side of the shroud ring 350 facing away from the main flow path, said coating being attached to the shroud ring 350 and made of a comparatively soft material.

The shroud ring 350 forms a projecting area 351, received in the recess 320 of the blade root 310 and held positively in the blade root 310. Here the area 351 of the shroud ring 350 forms lateral faces 352 extending parallel to the oblique inner contact faces 313 of the blade root fingers 312, so that the area 351 of the shroud ring 350 and the recess 320 of the blade root 310 have shapes corresponding to one another.

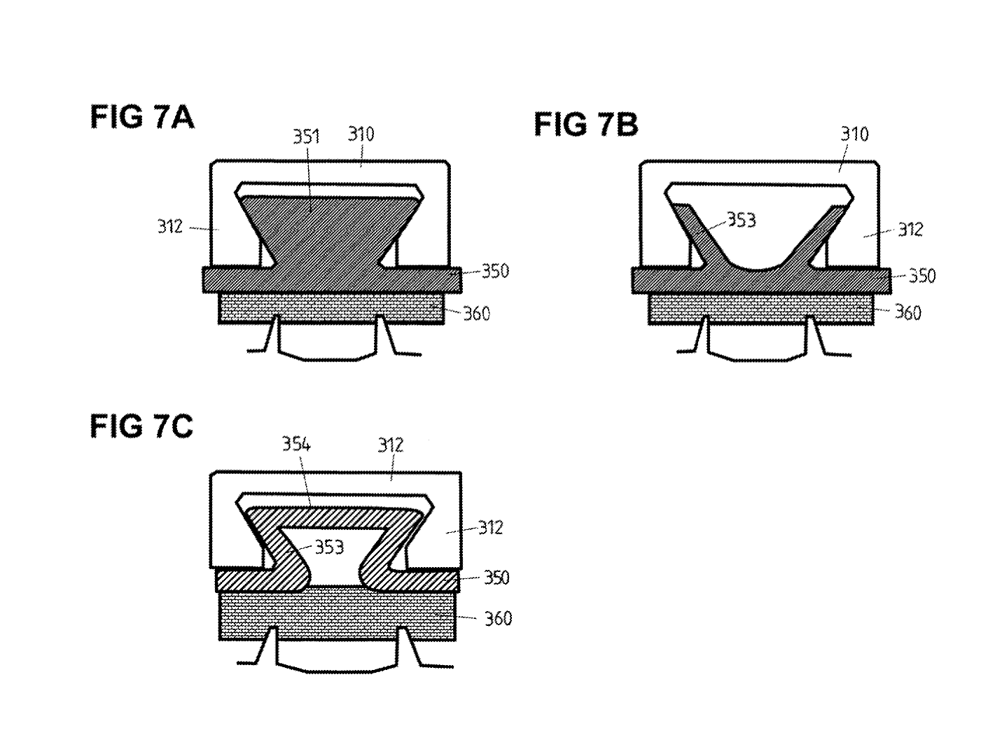

It is furthermore provided that an anti-wear sleeve 330 is arranged between the facing contact faces 313, 352 of the blade root fingers 312 and the shroud ring 350 in the area of the blade root fingers 312. The anti-wear sleeve 330 here has two legs 331, 332 provided at an angle to one another and adjoining the faces 313, 314 respectively of the blade root fingers 312. The anti-wear sleeve 330 is used in the contact area of the blade root fingers 312 and the shroud ring 350 to prevent wear and hence any loosening of the connection between these components. The use of such anti-wear sleeves 330 is however optional, as is explained further in reference to FIG. 7.

The shroud ring 350 extends along at least part of the circumference of the blade row. It is an advantage when the shroud ring 350 is in contact by its axially forward and rearward edge areas, as shown, with the radial contact faces 314 of the blade root fingers 312. That side of the shroud ring 350 facing away from the main flow path is substantially flat and extends in the axial direction, with the abradable coating 360 being arranged on this side. Although the use of an abradable coating 360 of this type is advantageous in many design variants, it is however not obligatory.

The shroud arrangement according to FIGS. 3 and 4, like the other shroud arrangements described, has the advantage that a secure connection can be obtained between blade root 310 and shroud 340 even with small axial dimensions of the blade/vane 10, 20 and hence of the blade root 310, in particular when the axial distance between the front and the rear blade root fingers 312 is comparatively short.

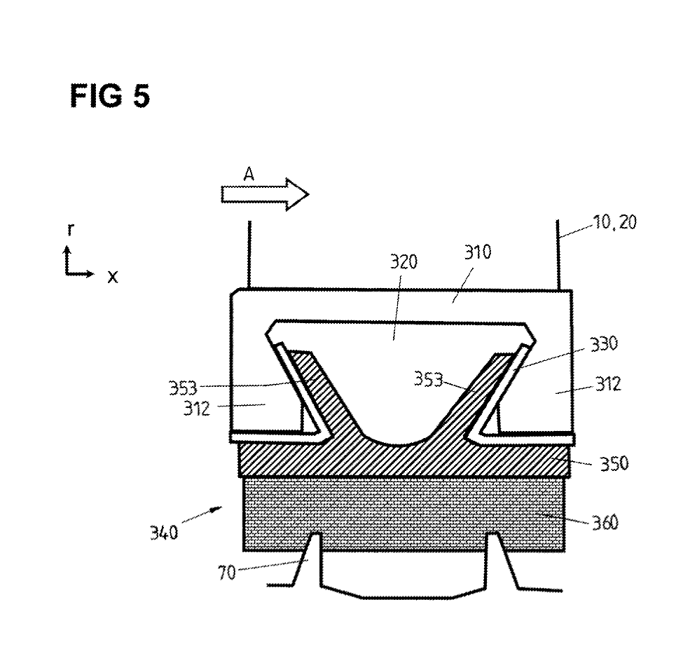

FIG. 5 shows a further exemplary embodiment of a shroud arrangement in the meridional view (x-r). The shroud arrangement includes, as in FIG. 4, a blade root 310 and a shroud 340, the latter including a shroud ring 350 and an abradable coating 360. Unlike in the exemplary embodiment of FIG. 4, the cross-sectional shape of the shroud ring 350 in the exemplary embodiment of FIG. 5 is selected such that it has material only in the area of contact with the blade root fingers 312. Accordingly, the shroud ring 350 does not include a closed area, as in the exemplary embodiment of FIG. 4, which fills the recess 320, but only two webs 353 extending parallel to the inner contact faces 313 of the blade root fingers 312 or to the corresponding sections of an anti-wear sleeve 330, and accordingly being arranged in a V-shape.

This exemplary embodiment has the advantage of reducing the material and weight of the shroud 350.

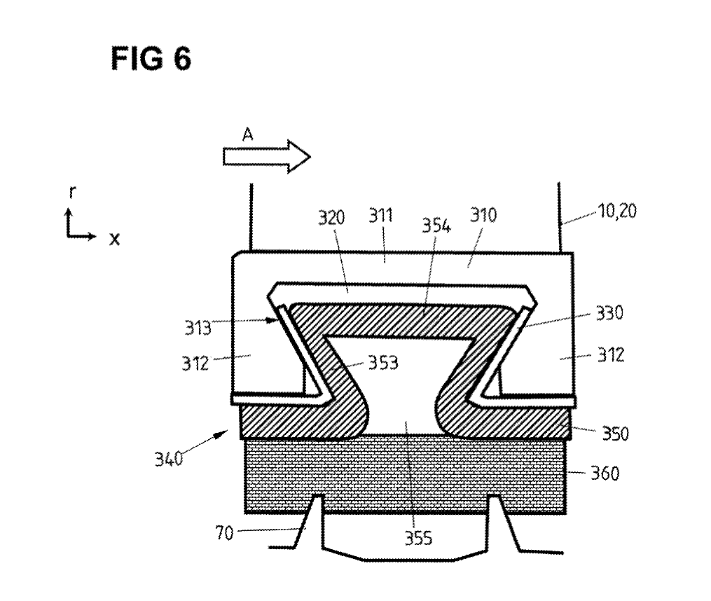

FIG. 6 shows in the meridional view (x-r) an exemplary embodiment of a shroud arrangement that also includes a blade root 310, a shroud 340 having a shroud ring 350 and an abradable coating 360 as well as an anti-wear sleeve 330. A recess 320 is provided between the blade root fingers 312, as in the exemplary embodiments of FIGS. 3 to 5.

The cross-sectional shape of the area of the shroud ring 350 arranged in the recess 320 is, in the exemplary embodiment of FIG. 6, designed such that the shroud ring 350 in the area of the recess 320 is designed triangular with two V-shaped legs or webs 353, which are aligned corresponding to the inner contact faces 313 of the blade root fingers 312, and provided with a base 354 connecting the ends of the two legs or webs 353 and facing the blade root platform 311, where a material-free interior 355 remains between the legs or webs 353 and the base 354. It can also be provided that the two legs or webs 353 do not touch one another on their sides facing away from the blade root 310 and thus form there an opening to the material-free interior 355. The provision of the shroud ring 350 in the area of the recess 320 is similar here in the sectional representation to the Greek letter Omega (Ω).

In alternative exemplary embodiments, not shown, of FIGS. 5 and 6, recesses in the material of the shroud ring 350 can be provided in a different way and can face away from the main flow path or face the main flow path.

FIGS. 7A to 7C show three exemplary embodiments of shroud arrangements corresponding to the exemplary embodiments of FIGS. 4, 5 and 6, without however anti-wear sleeves being provided in each case. In these modified exemplary embodiments, therefore, the shroud ring 350 is in direct contact with the corresponding contact faces 313, 314 of the blade root fingers 312 of the blade root 310.

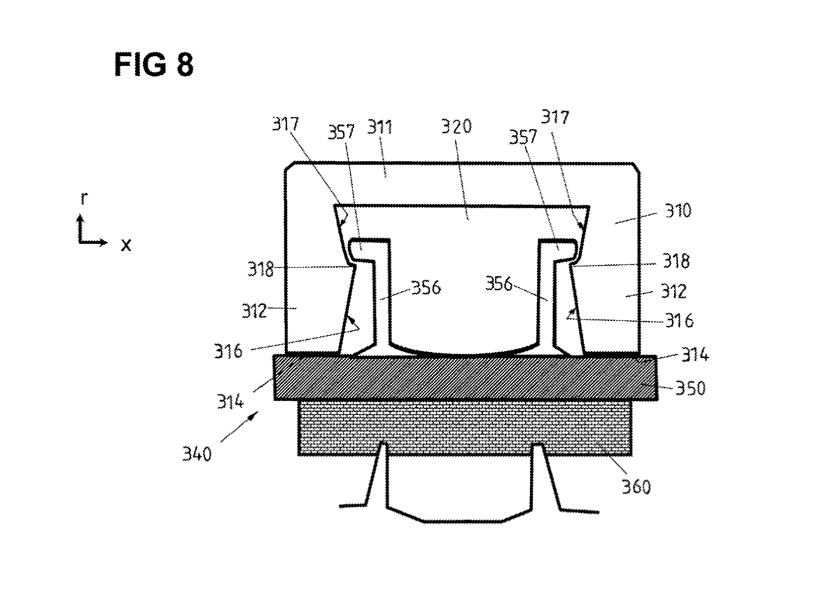

FIG. 8 shows a further exemplary embodiment of a shroud arrangement in the meridional view (x-r). The shroud arrangement includes a blade root 310 and a shroud 340. The blade root 310 has a blade root base 311 and two blade root fingers 312 extending from the blade root base 311 and radially away from the main flow path, and forming between them a recess 320.

The blade root fingers 312 form an axially forward blade root finger and an axially rearward blade root finger, and inner faces 316, 317 which however differ from the inner faces of the exemplary embodiments of FIGS. 3 to 7. Also provided is in each case a radial contact face 314 of the two blade root fingers 312.

The contact faces on the insides of the blade root fingers 312 thus each include an oblique sliding face 316 adjoining the radial contact face 314, and an oblique inner contact face 317 adjoining the blade root platform 311. In the area of the sliding faces 316, the axial extent of the recess 320 decreases in the radial direction towards the blades, and in the area of the contact faces 317 the axial extent of the recess 320 widens in the radial direction towards the blades. The blades themselves are not shown separately in the exemplary embodiment of FIG. 8, however are connected, as in the exemplary embodiment of FIGS. 3 to 7, to the blade root 310.

A locking projection 318 is provided at the transition between the sliding face 316 and the inner contact face 317.

The shroud 340 includes a shroud ring 350 and an abradable coating 360 fastened to it. For connection of the shroud ring 350 to the blade root 310, the shroud ring 350 forms two webs 356 which extend substantially radially in the direction of the blades or the main flow path and which at their ends each have a protruding locking lug 357 facing the adjacent contact face 317. The locking lug 357 engages here with the locking projection 318 of the blade root 310 when the webs 356 are inserted into the recess 320. The webs 356 form a single-piece portion of the shroud ring 350. It can be provided here that the shroud ring 350 is interrupted several times in the area of the webs 356 on the circumference, so that the webs 356 can have a structurally elastic effect and yield to pressure accordingly. It can be provided here that the number of interruptions of the two webs 356 on the circumference matches the number of blades or blade roots or is a multiple thereof.

With an elastic design of the webs 356 it is possible, for a connection of the shroud ring 350 to the blade root 310, to insert the webs 356 in the radial direction into the recess 320 of the blade root 310, with the elastic webs 356 initially being bent towards one another and then springing back after having passed the locking projection 318, so that they are in contact with the oblique contact face 317 and engaged with the locking projections 318 via the locking lugs 357. This ensures a firm connection between the blade root 310 and the shroud ring 350.

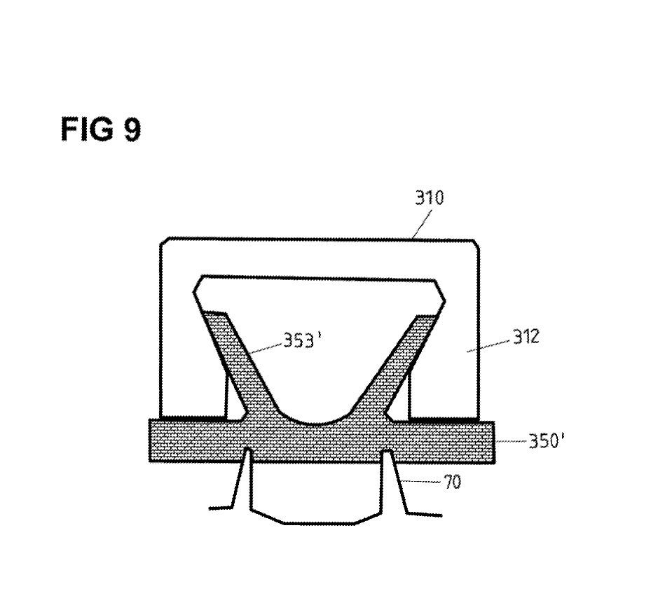

FIG. 9 shows an exemplary embodiment corresponding to the exemplary embodiment of FIG. 5, apart from the circumstance that the shroud ring 350′ additionally assumes the function of the abradable coating, so that the shroud ring and the abradable coating are combined to a single integral component 350′. It can be provided here that the integral shroud ring 350 is manufactured using an injection moulding or sintering method. Additionally, in the exemplary embodiment of FIG. 9 the use of an anti-wear sleeve has been dispensed with, but can however be alternatively provided.

The present invention, in its design, is not restricted to the exemplary embodiments presented above, which are only to be understood as examples. The blade root can thus for example form a recess in a manner different to that described above, into which recess an area or a component or an element of a shroud is inserted and held to connect blade root and shroud.

1. A shroud arrangement for a fluid-flow machine comprising:
at least one blade root which is designed to be connected to at least one blade/vane end of a row of rotor blades or stator vanes of a fluid-flow machine, or is connected to at least one such blade/vane end, and
a shroud that on the side of the blade root facing away from the blades/vanes is connected to said blade root,
wherein the blade root on the side facing away from the blades/vanes has two blade root fingers extending substantially in the radial direction and axially spaced from one another, said blade root fingers forming between them a recess being continuous in the circumferential direction, and at least one element or area of the shroud is arranged in the recess for fastening the shroud to the blade root, and
wherein the shroud has two webs extending into the recess and enclosed by the blade root fingers, with the two webs forming substantially a V-shaped arrangement.

2. The shroud arrangement in accordance with claim 1, wherein the recess formed by the blade root fingers has a concave shape, and the two webs are arranged positively inside the recess.

3. The shroud arrangement in accordance with claim 1, wherein the recess is designed dovetail-shaped in at least in one part-area, widening in the direction of the blades/vanes.

4. The shroud arrangement in accordance with claim 1, wherein each blade root finger forms at least one inner contact face which is at least partially facing the inner contact face of the respective other blade root finger.

5. The shroud arrangement in accordance with claim 1, wherein the webs arranged in a V-shape each extend parallel to an inner contact face of one of the blade root fingers.

6. The shroud arrangement in accordance with claim 1, wherein the shroud ring is interrupted several times in the circumferential direction in the area of the webs, so that the webs are designed elastic.

7. The shroud arrangement in accordance with claim 6, wherein the number of interruptions of the two webs on the circumference matches the number of blades/vanes or forms a multiple thereof.

8. The shroud arrangement in accordance with claim 1, wherein the shroud has a shroud ring, which is provided with the two legs arranged in the recess of the blade root, and extends along at least part of the circumference of the blade row.

9. The shroud arrangement in accordance with claim 8, wherein an abradable coating is arranged on the shroud ring on that side of the shroud ring facing away from the blade root.

10. The shroud arrangement in accordance with claim 1, wherein the recess between the blade root fingers has a symmetrical shape.

11. The shroud arrangement in accordance with claim 1, wherein furthermore at least one anti-wear sleeve is provided, which is arranged between adjoining faces of the blade root and of the shroud ring.

12. The shroud arrangement in accordance with claim 1, wherein the two webs arranged in a V-shape are connected by a base facing the blade root, with a material-free interior remaining between the webs and the base.

13. The shroud arrangement in accordance with claim 12, wherein the arrangement of the two webs and the base in the sectional view is designed approximately corresponding to the Greek letter Omega.

14. The shroud arrangement in accordance with claim 1, wherein the shroud ring forms in the direction of the blades/vanes in the cross-section of the meridional plane a triangular projection arranged in the recess, with the two legs forming V-shaped webs of the triangular projection.

15. A blade row of a fluid-flow machine having a shroud arrangement in accordance with claim 1.
